(19) United States
(12) Patent Application Publication
(10) Pub. No.: US 2020/0254378 A1
(43) Pub. Date: Aug. 13, 2020

(54) CONCENTRATED CATALYST COMBUSTION SYSTEM HAVING ACTIVE CONCENTRATION RATIO CONTROL MEANS

(71) Applicant: CHANGSUNG ENGINEERING CO., LTD., Buk-gu, Gwangju (KR)

(72) Inventor: Chang Keun Kim, Gwangsan-gu, Gwangju (KR)

(21) Appl. No.: 16/651,963

(22) PCT Filed: Sep. 21, 2018
(86) PCT No.: PCT/KR2018/011222

§ 371 Date: Mar. 27, 2020

(30) Foreign Application Priority Data
Sep. 29, 2017 (KR) 10-2017-0128318

(51) Int. Cl. B01D 53/00; B01D 53/75

(52) U.S. Cl. CPC B01D 53/005; B01D 53/86; B01D 53/75

(57) ABSTRACT

Provided is a concentrated catalyst combustion system including an active concentration rate control means. The concentrated catalyst combustion system including an active concentration rate control means includes an absorption blower fan absorbing exhaust gas containing volatile organic compounds (VOCs), a VOC concentrator into which the exhaust gas passing through the absorption blower fan is introduced, and in which adsorption and desorption of the VOCs are carried out, a flow rate regulating blower fan absorbing a portion of the exhaust gas flowing into the VOC concentrator in a direction in which the VOCs are desorbed, a concentration measurer, arranged between the VOC concentrator and the flow rate regulating blower fan, measuring the concentration of the VOCs after desorption, a catalyst combustor burning concentrated VOCs provided by the flow rate regulating blower fan, and a controller controlling the flow rate regulating blower fan to regulate the flow rate absorbed from the VOC concentrator to maintain within a certain range the concentration of the VOCs measured by the concentration measurer.

### TECHNICAL FIELD

One or more embodiments of the present disclosure relate to a concentrated catalyst combustion system including an active concentration rate control means, and more particularly, to a concentrated catalyst combustion system allowing volatile organic compounds to be burned without using auxiliary fuel by actively regulating the concentrated concentration of the volatile organic compounds contained in exhaust gas.

### BACKGROUND ART

One or more embodiments of the present disclosure relate to an air pollution prevention technology that collects volatile organic compounds contained in exhaust gas and concentrates the volatile organic compounds to a combustible concentration to burn and purify the same.

Volatile organic compounds discharged from workplaces in which printing, painting, or similar work is performed not only produce odors but also pollute the air and seriously affect the human body. Therefore, a technology that recovers or burns volatile organic compounds by separating them from the exhaust gas is recommended. A combustion technology may be the optimal solution to the problem. However, when the concentration of the volatile organic compounds contained in the exhaust gas is low, additional costs may be incurred since auxiliary fuel needs to be used to raise the temperature to be combustible.

A concentration combustion technology for raising the concentration of the volatile organic compounds to be combustible has been developed to solve the problem involved in using auxiliary fuel. Conventional Korean Patent No. 10-1719540 (hereinafter referred to as ‘prior art document’) relates to the concentrating of volatile organic compounds.

Referring to FIG. 1, the combustion apparatus according to the prior art document includes a volatile organic compound (VOC) gas collector 1, a zeolite concentrator 2, a main blower fan 3, a desorption blower fan 4, and a ceramic catalyst oxidation equipment 5.

The VOC gas collector 1 collects exhaust gas, and the zeolite concentrator 2, positioned at the rear end of the VOC gas collector 1, filters volatile substances by adsorbing them. The main blower fan 3 discharges to the inside, gas from which volatile substances have been removed from the zeolite concentrator 2. The desorption blower fan 4 cools down hot air provided by the ceramic catalyst oxidation equipment 5 to a certain temperature to desorb and remove the volatile substances in an adsorption zone of the zeolite concentrator 2. The volatile substances removed through the desorption blower fan 4 are moved to the ceramic catalyst oxidation equipment 5 and burned.

According to the prior art document, the concentration of the volatile organic compounds is raised in the process of adsorption and desorption in the zeolite concentrator 2. However, some limitations have been found in the prior art document, as follows.

When the exhaust concentration of the volatile organic compounds is significantly changed, even if the exhaust gas passes through the zeolite concentrator 2, it is difficult to maintain a constant concentrated concentration of the volatile organic compounds. According to the prior art document, since the flow rate of the exhaust gas absorbed by the main blower fan 3 and the flow rate of the exhaust gas absorbed by the desorption blower fan 4 are maintained constant, it is difficult to maintain a constant concentrated concentration after desorption according to the concentration of the volatile organic compounds contained in the exhaust gas flowing into the zeolite concentrator 2. If the concentrated concentration falls below a certain level, auxiliary fuel may be still needed to burn the volatile organic compounds, and in contrast, if the concentrated concentration rises above a certain level, a combustion apparatus may be overheated, which increases the risk of explosion.

Therefore, one or more embodiments of the present disclosure provide a combustion system allowing volatile organic compounds to be concentrated to a combustible level even when the concentration of the volatile organic compounds contained in the exhaust gas varies.

### PRIOR ART DOCUMENTS

### Patent Documents

(Patent document 1) Korean registered patent publication No. 10-1719540 (Registration No.)

### DESCRIPTION OF EMBODIMENTS

### Technical Problem

One or more embodiments of the present disclosure provide a concentrated catalyst combustion system including an active concentration rate control means allowing volatile organic compounds to be concentrated to a combustible level and burned without using auxiliary fuel even when the concentration of the volatile organic compounds contained in exhaust gas varies.

### Solution to Problem

According to an embodiment of the present disclosure, a concentrated catalyst combustion system including an active concentration rate control means comprises:

an absorption blower fan absorbing exhaust gas containing volatile organic compounds (VOCs);

a VOC concentrator into which the exhaust gas passing through the absorption blower fan flows, and in which adsorption and desorption of the VOCs are carried out;

a flow rate regulating blower fan absorbing a portion of the exhaust gas flowing into the VOC concentrator in a direction in which the VOCs are desorbed;

a concentration measurer, arranged between the VOC concentrator and the flow rate regulating blower fan, measuring the concentration of the VOCs after desorption;

a catalyst combustor burning concentrated VOCs provided by the flow rate regulating blower fan; and

a controller regulating the flow rate absorbed by the flow rate regulating blower fan from the VOC concentrator to maintain within a certain range the concentration of the VOCs measured by the concentration measurer.

The controller includes a temperature rise calculator calculating a temperature rise according to the concentration of the volatile organic compounds after desorption.

When the combustion start temperature at which combustion starts in the catalyst combustor is A ° C., the temperature rise calculated by the temperature rise calculator is B ° C., and the heat resistance temperature of the combustion catalyst used in the catalyst combustor is C ° C., it is desirable that the flow rate absorbed by the flow rate regulating blower fan be regulated such that the relationship A+B<C is satisfied.

In addition, it is desirable that the controller include a first bypass damper that is branched from a line connecting the absorption blower fan and the VOC concentrator and connected to a line connecting the VOC concentrator and the concentration measurer to bypass the exhaust gas that has passed through the absorption blower fan before the exhaust gas flows into the VOC concentrator.

Moreover, it is desirable that a heat exchanger and an electric heater be sequentially arranged on a flow path where a portion of the exhaust gas is discharged from the VOC concentrator and flows back into the VOC concentrator, and a second bypass damper be arranged between a line connecting the VOC concentrator and the heat exchanger and a line connecting the heat exchanger and the electric heater to introduce a portion of the exhaust gas that has passed through the VOC concentrator to the front end of the electric heater.

Furthermore, it is desirable that a diluted air injection damper injecting diluted air be arranged on a line connecting the VOC concentrator and the concentration measurer.

### Advantageous Effects of Disclosure

One or more embodiments of the present disclosure provide a concentrated catalyst combustion system including an active concentration rate control means capable of concentrating volatile organic compounds to a combustible concentration even when the concentration of the volatile organic compounds contained in exhaust gas varies.

The concentrated catalyst combustion system is also able to burn the volatile organic compounds without using any auxiliary fuel by concentrating and burning the volatile organic compounds, and moreover, combustion heat of the volatile organic compounds has the advantage of being recovered and recycled for the combustion of volatile organic compounds.

### BRIEF DESCRIPTION OF DRAWINGS

FIG. 1 is a schematic diagram of an existing combustion apparatus;

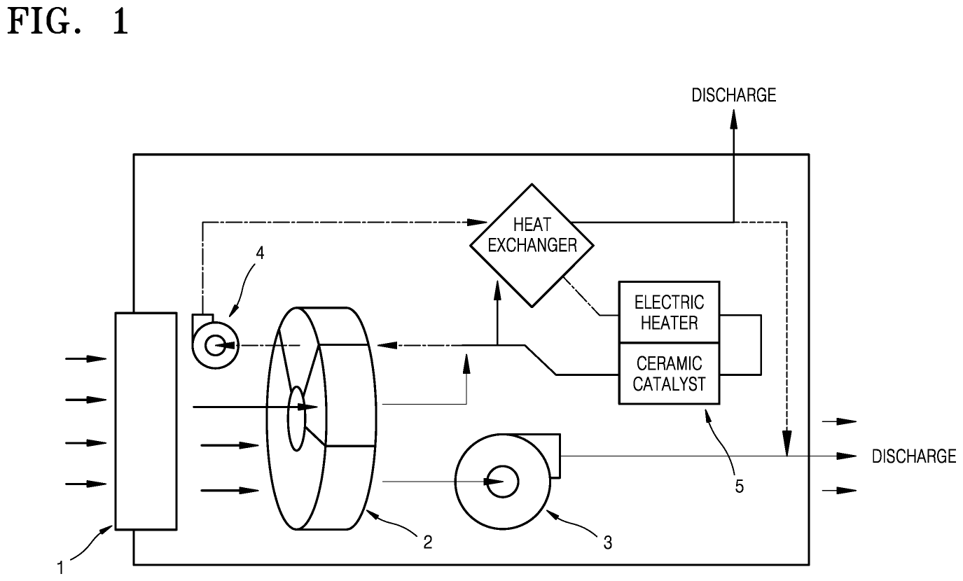

FIG. 2 is a schematic diagram of a concentrated catalyst combustion system, according to an embodiment of the present disclosure;

FIG. 3 is a diagram illustrating an extract of the main portion of FIG. 2;

FIG. 4 is a diagram illustrating the main portion of FIG. 2 in detail;

FIG. 5 is a block diagram of a configuration for regulating the concentration of volatile organic compounds;

FIG. 6 is a diagram illustrating operations of a flow rate regulating blower fan, a first bypass damper, and a diluted air injection damper according to exhaust gas inflow concentration; and

FIG. 7 is experimental data of a concentrated catalyst combustion system, according to an embodiment of the present disclosure.

### MODE OF DISCLOSURE

Hereinafter, preferred embodiments of the present disclosure will be described in greater detail with reference to the accompanying drawings.

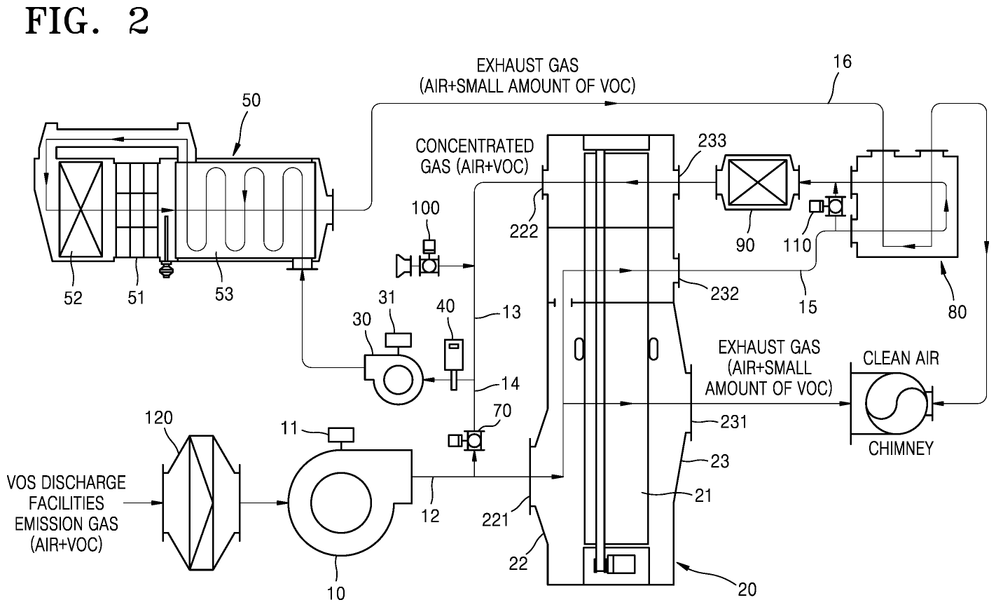

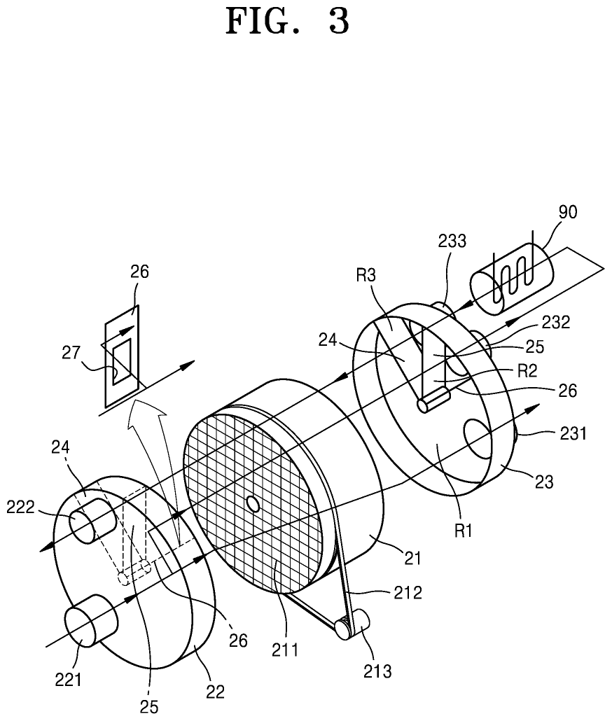

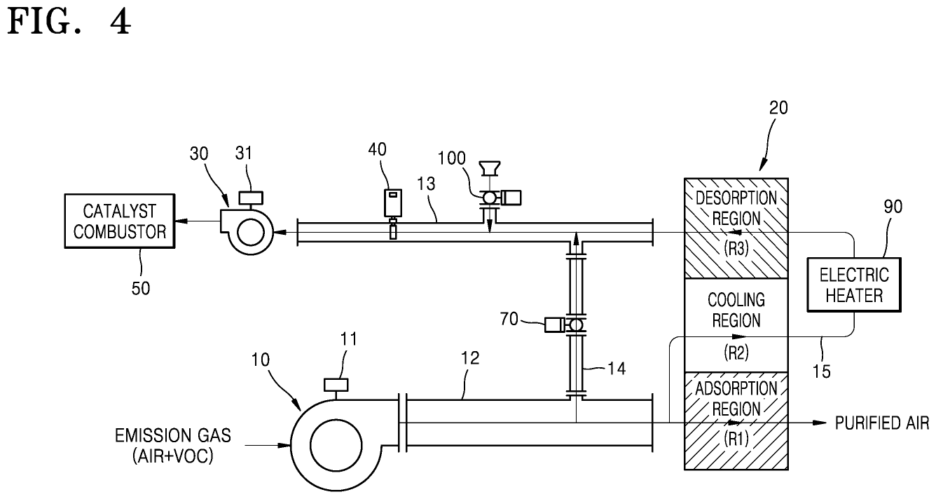

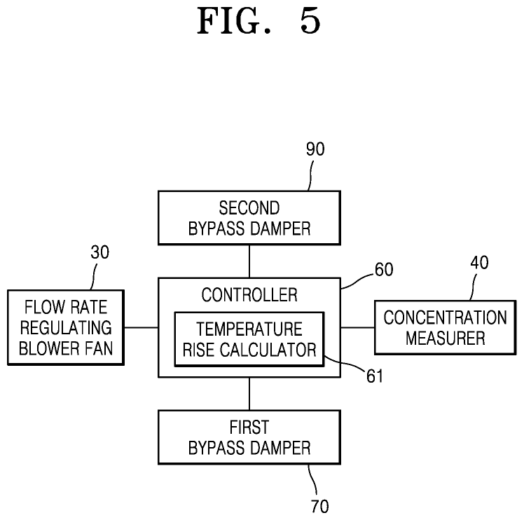

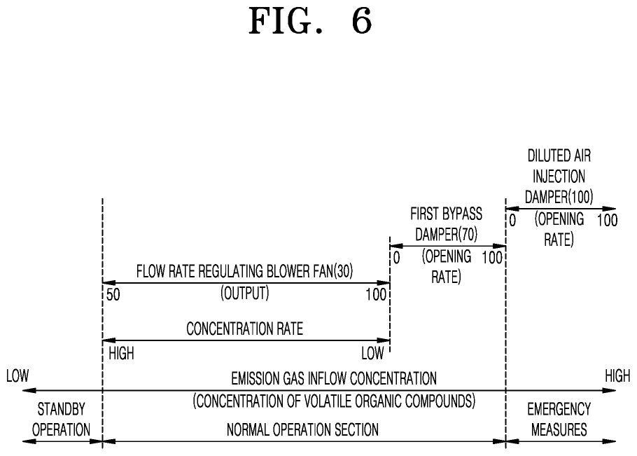

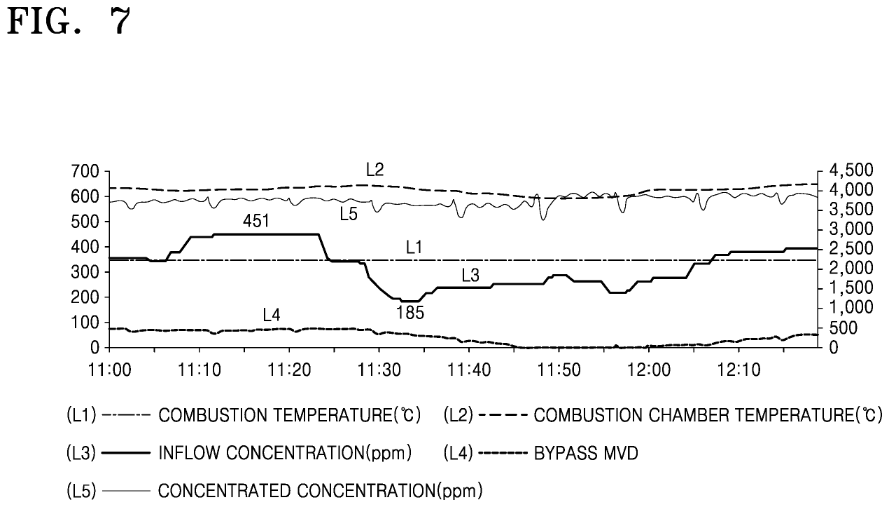

FIG. 2 is a schematic diagram of a concentrated catalyst combustion system, according to an embodiment of the present disclosure. FIG. 3 is a diagram illustrating an extract of the main portion of FIG. 2, and FIG. 4 is a diagram illustrating the main portion of FIG. 2 in detail. FIG. 5 is a block diagram of a configuration for regulating the concentration of volatile organic compounds, FIG. 6 is a diagram illustrating operations of a flow rate regulating blower fan, a first bypass damper, and a diluted air injection damper according to exhaust gas inflow concentration, and FIG. 7 is experimental data of a concentrated catalyst combustion system, according to an embodiment of the present disclosure.

Referring to FIG. 2, a concentrated catalyst combustion system including an active concentration rate control means includes an absorption blower ran 10, a VOC (volatile organic compound) concentrator 20, a flow rate regulating blower fan 30, a concentration measurer 40, a catalyst combustor 50, and a controller 60, according to an embodiment of the present disclosure.

The absorption blower fan 10 absorbs exhaust gas containing VOCs. Provided is the concentrated catalyst combustion system to treat the VOCs generated from facilities in which printing, painting, or similar work is performed, and the exhaust gas containing the VOCs is absorbed by the absorption blower fan 10.

Output of the absorption blower fan 10 may be regulated by an inverter 11. According to an embodiment of the present disclosure, a pretreatment filter 120 is arranged at the front end of the absorption blower fan 10 to primarily filter particulate matter contained in the exhaust gas. The absorption blower fan 10 and the VOC concentrator 20 to be described herein below are connected by an inlet duct 12.

The VOC concentrator 20 is provided for adsorption and desorption of the VOCs. The exhaust gas that has passed through the absorption blower fan 10 flows into the VOC concentrator 20. Referring FIG. 3, the VOC concentrator 20 employed in an embodiment of the present disclosure includes a rotating member 21, a front cover part 22, and a rear cover part 23.

The rotating member 21 is cylindrical in shape, and an adsorbent adsorbing the VOCs is provided therein. In detail, the inside of the rotating member 21 is a honeycomb in shape, and each compartment 211 is filled with a ceramic sheet coated with an adsorbent such as zeolite.

A belt 212 is coupled to an outer circumferential surface of the rotating member 21, and the belt 212 rotates the rotating member 21 caught on the belt 212 with a motor 213. VOCs of the exhaust gas that has passed through the absorption blower fan 10 and flown into the VOC concentrator 20 are adsorbed to the rotating member 21. On the other hand, when a portion of the exhaust gas passes through the VOC concentrator 20 and flows back into the VOC concentrator 20, the VOCs adsorbed to the rotating member 21 are desorbed.

The front cover part 22 is coupled to the front end of the rotating member 21. The front cover part 22 is provided with a first inlet 221 where the exhaust gas flows in and a first outlet 222 where the exhaust gas that has flown in back from a rear side of the VOC concentrator 20 for desorption is discharged.

The front cover part 22 is divided into three regions. Three partition walls 26, 25, and 24 are provided in the front cover part 22 to divide the front cover part 22 into three regions. As illustrated in FIG. 3, when the first, second, and third partition walls 26, 25, and 24 are sequentially arranged, a first region R1 between the first partition wall 26 and the third partition wall 24, a second region R2 between the first partition wall 26 and the second partition wall 25, and a third region R3 between the second partition wall 25 and the third partition wall 24 are formed. The ratio of the first, second, and third regions R1, R2, and, R3 is approximately 8:1:1.

The first inlet 221 of the front cover part 22 is arranged in the first region R1, and the first outlet 222 is arranged in the third region R3. VOCs of most of the exhaust gas entering through the first inlet 221 are adsorbed and purified while passing through the rotating member 21 and discharged through a second outlet 231 of the rear cover part 23 coupled to the rear side of the rotating member 21. A through hole 27 is formed in the first partition wall 26. The through hole 27 guides a portion of the exhaust gas introduced through the first inlet 221 to the second region R2.

The rear cover part 23 is coupled to the rear side of the rotating member 21. The rear cover part 23 is divided into three regions like the front cover part 22. Like the front cover part 22, three partition walls 26, 25, and 24 are provided in the rear cover part 23 and partitioned into first, second, and third regions R1, R2, and R3. The positions of the partition walls 26, 25, and 24 and of the regions R1, R2, and R3 arranged in the rear cover part 23 are the same as those of the partition walls 26, 25, and 24 and of the regions R1, R2, and R3 arranged in the front cover part 22.

On the rear side of the rear cover part 23 are arranged the second outlet 231, a third outlet 232, and a second inlet 233.

The second outlet 231 is provided to discharge most of the exhaust gas flowing into the first inlet 221 to the rear end side of the VOC concentrator 20. The third outlet 232 discharges the exhaust gas flowing into the second region R2 through the through hole 27. The second inlet 233 is provided to introduce the exhaust gas from the VOC concentrator 20 into the third region R3 of the VOC concentrator 20 through the third outlet 232. The third outlet 232 and the second inlet 233 are connected by a return duct 15.

The flow rate regulating blower fan 30 is provided to absorb a portion of the exhaust gas flowing into the VOC concentrator 20 in a direction in which the VOC is desorbed. In detail, when a portion of the exhaust gas flowing into the VOC concentrator 20 exits the VOC concentrator 20 through the second region R2, the flow rate regulating blower fan 30 absorbs the exhaust gas in order for the exhaust gas to pass through the third region R3 of the VOC concentrator 20.

As the exhaust gas passing through the return duct 15 is heated and passes through the third region R3, desorption of the VOC is carried out. The flow rate regulating blower fan 30 is arranged on a concentrated gas inlet duct 13 connecting the first outlet 222 of the front cover part 22 and the catalyst combustor 50.

The concentration measurer 40 is provided to measure the concentration of the VOCs after desorption. The concentration measurer 40 is arranged between the VOC concentrator 20 and the flow rate regulating blower fan 30. In other words, the concentration measurer 40 is arranged on the concentrated gas inlet duct 13.

The catalyst combustor 50 is provided to burn the concentrated VOCs supplied by the flow rate regulating blower fan 30. Harmful VOCs contained in the exhaust gas is burned by the catalyst combustor 50 and removed. According to the present embodiment, the catalyst combustor 50 includes a preheater 52, a combustion catalyst 51, and a waste heat recovery part 53.

The catalyst combustor 50 is provided with the concentrated VOCs and burns the VOCs using catalyst promoting combustion. The preheater 52 is provided to raise the temperature of a combustion chamber to the start temperature at which combustion starts in the catalyst combustor 50. For example, when combustion starts at about 350° C., the preheater 52 raises the temperature of the combustion chamber to the same temperature.

The combustion catalyst 51 is provided to burn the VOCs, using catalyst promoting combustion.

The waste heat recovery part 53 is provided to recover heat generated when the concentrated gas is burned. The concentrated gas that has passed through the concentrated gas inlet duct 13 flows into the waste heat recovery part 53, and the concentrated gas receives heat generated from the combustion catalyst 51 to be preheated. Whereas preheating auxiliary fuel is used to heat the preheater 52 at the initial stage of operation of the combustion catalyst 51, the preheating auxiliary fuel is not used when the combustion catalyst 51 operates normally since the waste heat recovery part 53 performs a heat exchange, or the combustion catalyst 51 is able to operate normally even with a significantly reduced amount of fuel.

The controller 60 is provided to regulate the flow rate that the flow rate regulating blower fan 30 absorbs from the VOC concentrator 20 to maintain within a certain range the concentration of the VOCs measured by the concentration measurer 40. The controller 60 controls an inverter 31 of the flow rate regulating blower fan 30.

The controller 60 includes a temperature rise calculator 61.

The temperature rise calculator 61 is provided to calculate a temperature rise of the VOCs when the VOCs are burned according to the concentration of the VOCs after the VOCs are desorbed. The temperature rise calculator 61 may calculate the temperature rise based on the calorific value of organic compounds. The temperature rise calculator 61 receives concentration of the concentrated VOCs from the concentration measurer 40.

When the combustion start temperature at which combustion starts in the catalyst combustor 50 is A ° C., the temperature rise calculated by the temperature rise calculator 61 is B ° C., and the heat resistance temperature of the combustion catalyst used in the catalyst combustor 50 is C ° C., the controller 60 regulates the flow rate absorbed by the flow rate regulating blower fan 30 such that the relationship A+B<C is satisfied.

For example, when the combustion start temperature in the catalyst combustor 50 is 350° C. and the heat resistance temperature of the catalyst is 700° C., the temperature of the combustion chamber is allowed to rise below about 350° C. by the combustion of the VOCs. The temperature rise of the VOCs depends on the concentration of the VOCs.

For example, when exhaust gas flowing into the VOC concentrator 20 via the absorption blower fan 10 consists of VOCs such as 10.5% of ethanol, 10.7% of normal propyl acetate (NPAC), 1.8% of propylene glycol mono methyl ether, 76.6% of ethyl acetate, and the like, if the exhaust gas is discharged at 420 m³ per minute at a concentration of 400 ppm, 378 m³ of 420 m³ is adsorbed per minute to the VOC concentrator 20 by about 95% of the VOCs or greater while passing through the first region R1, and purified exhaust gas containing a small amount of VOCs is discharged to the atmosphere through the second outlet 231. The remaining 42 m³ of the exhaust gas flows back into the VOC concentrator 20 after passing through a return duct 15 after via the second region R2.

The exhaust gas is heated (to about 200° C., according to the present embodiment) by an electric heater 90 arranged in the return duct 15 and passes through the third region R3 of the VOC concentrator 20 to desorb the adsorbed VOCs. In that process, the concentration of the VOCs is concentrated approximately to a high concentration of 3820 ppm and then flows into the catalyst combustor 50. Since the VOCs generate combustion heat of about 239° C. at the concentrated concentration, the internal temperature of the catalyst combustor 50 rises up to about 589° C.

When the concentration of the VOCs introduced through the absorption blower fan 10 is low, the flow rate absorbed by the flow rate regulating blower fan 30 needs to be decreased to raise the concentration of the concentrated gas desorbed from the VOC concentrator 20. In contrast, when the concentration of the VOCs introduced through the absorption blower fan 10 is high, the flow rate absorbed by the flow rate regulating blower fan 30 needs to be increased to lower the concentration of the concentrated gas.

As illustrated in FIG. 5, the controller 60 controls the flow rate of the flow rate regulating blower fan 30 in order that the temperature that adds the combustion start temperature and the temperature rise calculated by the temperature rise calculator 61 does not exceed the heat resistance temperature of the catalyst. As described above, when the amount of the exhaust gas flowing into the VOC concentrator 20 is maintained at a constant level, if the flow rate absorbed by the flow rate regulating blower fan 30 increases, the concentrated concentration becomes low, and in contrast, if the flow rate absorbed by the flow rate regulating blower fan 30 decreases, the concentrated concentration becomes high.

In addition, the controller 60 receives the concentration of the VOCs after desorption from the concentration measurer 40 to regulate the flow rate of the flow rate regulating blower fan 30, and the temperature rise calculator 61 calculates the temperature rise based on the calorific value according to the concentration of the VOCs measured by the concentration measurer 40.

The calorific value may be calculated in the following two methods: Concentration of each corresponding material is calculated individually, and accordingly, this method is based on the calorific value of each material, and otherwise, the calorific value may be calculated based on the data given in advance experimentally for convenience of application at workplace.

For example, when the concentration of the VOCs exists within a particular range, an approximate calorific value may be given by repeated experimental results. From an experimental point of view, if a database of the calorific value regarding the concentration in a particular range is made, the temperature rise calculator 61 may receive the concentration value of VOCs from the concentration measurer 40 to calculate the temperature rise based on the data.

According to the present embodiment, a concentrated catalyst combustion system includes a first bypass damper 70, a heat exchanger 80, a second bypass damper 110, and a diluted air injection damper 100.

The first bypass damper 70 is provided to bypass the exhaust gas before the exhaust gas that has passed through the absorption blower fan 10 flows into the VOC concentrator 20. More specifically, the first bypass damper 70 is provided to bypass the exhaust gas to the front end of the concentration measurer 40 to directly regulate the concentration of the VOCs flowing into the catalyst combustor 50 before the exhaust gas flows into the VOC concentrator 20.

In detail, the first bypass damper 70 is branched from a line connecting the absorption blower fan 10 and the VOC concentrator 20 to be connected to a line connecting the VOC concentrator 20 and the concentration measurer 40.

As illustrated in FIG. 4, the first bypass damper 70 is branched from the inlet duct 12 to be arranged in a bypass duct 14 connected to the concentrated gas inlet duct 13, the bypass duct 14 is connected to the front end of the concentration measurer 40, and the exhaust gas that has passed through the bypass duct 14 passes through the concentration measurer 40.

Concentration of the concentrated VOCs flowing into the catalyst combustor 50 needs to be concentrated to a concentration combustible by itself after the start of combustion. In the case of VOCs with a high concentration exceeding a permissible range, its concentration range needs to be carefully regulated because of a risk of explosion.

When the concentration of the VOCs flowing into the VOC concentrator 20 is significantly high, and accordingly, the concentration of the VOCs contained in the concentrated gas exceeds an appropriate range although adsorption and desorption have been carried out through the VOC concentrator 20, the first bypass damper 70 is opened to lower the concentration of the VOCs contained in the desorbed gas by bypassing a portion of the exhaust gas.

As illustrated in FIG. 5, when the concentration of the VOCs measured by the concentration measurer 40 exceeds an appropriate range (in other words, since the concentration of the VOCs determines the temperature raised by the catalyst combustor 50, the appropriate range of the concentration is directly related to the calculation of an appropriately raised temperature), the controller 60 opens the first bypass damper 70 to lower the concentration value by diluting the concentrated gas. As the concentration of the VOC significantly exceeds the appropriate range, the controller 60 raises the opening rate of the first bypass damper 70.

According to the present embodiment, the amount of the exhaust gas distributed to the bypass duct 14 does not exceed 50% of the design capacity of the catalyst combustor 50. When the amount of the exhaust gas distributed to the bypass duct 14 exceeds 50% of the design capacity of the catalyst combustor 50, since the concentration of the VOC becomes significantly low, the concentration value combustible in the catalyst combustor 50 is unable to be maintained.

As described above, the method regulating the concentration value by bypassing the exhaust gas is able to lower the concentration value through the first bypass damper 70 when the concentration of the VOC is unable to be lowered to an appropriate range even if the output of the flow rate regulating blower fan 30 is maximized. Therefore, the catalyst combustion system according to one or more embodiments of the present disclosure may be effectively used even at workplaces where the concentration variation of the VOCs contained in the exhaust gas is significantly high.

The heat exchanger 80 is arranged on a flow path where a portion of the exhaust gas is discharged from the VOC concentrator 20 and then flows back into the VOC concentrator 20. In other words, the heat exchanger 80 is arranged on the return duct 15. Exhaust gas having a high temperature that has passed through the catalyst combustor 50 passes inside the heat exchanger 80, and the exhaust gas having a high temperature in the heat exchanger 80 is discharged to a chimney after transferring heat to the exhaust gas that has exited the VOC concentrator 20.

Like the heat exchanger 80, the electric heater 90 is arranged on a flow path where a portion of the exhaust gas exits the VOC concentrator 20 and then flows back into the VOC concentrator 20. The electric heater 90 is arranged at the rear end of the heat exchanger 80. The exhaust gas that has passed through the second region R2 passes through the heat exchanger 80 and the electric heater 90 while flowing through the return duct 15.

The electric heater 90 is provided to raise the temperature of the exhaust gas to a temperature at which desorption may be carried out when the exhaust gas flows back into the VOC concentrator 20. According to the present embodiment, the electric heater 90 raises the temperature of the exhaust gas to about 200° C. During the normal operation of the system, as the exhaust gas heated by the electric heater 90 flows into the third region R3 of the VOC concentrator 20, desorption is carried out, and the temperature of the second region R2 adjacent to the third region R3 is raised to about 120° C. through indirect heating.

The second bypass damper 110 is provided to introduce the exhaust gas that has passed through the VOC concentrator 20 to the front end of the electric heater 90. In other words, the second bypass damper 110 is provided to introduce the exhaust gas directly to the electric heater 90 side before the exhaust gas passes through the heat exchanger 80. The second bypass damper 110 is arranged on the line connecting the VOC concentrator 20 and the heat exchanger 80 and the line connecting the heat exchanger 80 and the electric heater 90.

The heat exchanger 80 may not be heated adequately at the initial stage of operation of the system. Thus, a certain period of time needs for the heat exchanger 80 to be adequately heated. Thus, at the initial stage of operation of the system, the second bypass damper 110 needs to be opened for the exhaust gas to be directly introduced into the electric heater 90 without passing through the heat exchanger 80.

When the system operates normally, the second bypass damper 110 is closed, and the exhaust gas sequentially passes through the heat exchanger 80 and the electric heater 90. The opening and closing of the second bypass damper 110 is controlled by the controller 60. The controller 60 may be implemented to open the second bypass damper 110 for a certain period of time after the system starts operating, or to close the second bypass damper 110 when the heat exchanger 80 reaches a certain temperature.

The diluted air injection damper 110 is provided to inject diluted air into the line connecting the VOC concentrator 20 and the concentration measurer 40, which is the concentrated gas inlet duct 13. The diluted air injection damper 110 is provided to lower the concentration value quickly when the concentration of the concentrated VOC exceeds the appropriate range even when the first bypass damper 70 arranged in the bypass duct 14 is opened 100%. The controller 60 may control the diluted air injection damper 100 to be opened when emergency measures are required as described above.

FIG. 6 is a diagram schematically illustrating the operation process of a concentrated catalytic combustion system, according to an embodiment of the present disclosure.

As illustrated in FIG. 6, when looking at the normal operation section of the system, it is necessary to raise the concentration rate when the concentration of VOCs contained in the exhaust gas is low. In that case, the concentration of the VOCs is measured to be low by the concentration measurer 40, and the controller 60 reduces the output of the flow rate regulating blower fan 30 to increase the concentration of the VOCs by absorbing a small amount of the exhaust gas.

In contrast, it is necessary to lower the concentration rate when the concentration of the VOCs contained in the exhaust gas is high. In that case, the controller 60 increases the output of the flow rate regulating blower fan 30 to lower the concentration of the VOCs by absorbing a large amount of the exhaust gas.

When the concentration still exceeds the appropriate range although an attempt is made to lower the concentration of the VOCs by maximizing the output of the flow rate regulating blower fan 30, the controller 60 opens the first bypass damper 70 in an attempt to lower the concentration.

When the concentration of the VOCs exceeds the appropriate range although the output of the flow rate regulating blower fan 30 is maximized and the first bypass damper 70 is opened to the maximum, the controller 60 lowers the concentration of the VOCs to inject diluted air by opening the diluted air injection damper 100.

FIG. 7 is a graph illustrating an experimental data of a concentrated catalyst combustion system including an active concentration rate control means, according to an embodiment of the present disclosure.

As illustrated in FIG. 7, although the concentration of VOCs contained in exhaust gas is introduced into the absorption blower fan 10 in the range of 185 ppm to 451 ppm, as shown by L3, the concentrated concentration of the VOCs is maintained at an appropriate level without a significant change, as shown by L5. L1 shows that the combustion start temperature in the catalyst combustor 50 is about 350° C., and L2 shows that the temperature of the combustion chamber is maintained at about 600° C. to 650° C. due to the combustion temperature generated as VOC is burned. On the other hand, when highly concentrated VOCs are introduced, the first bypass damper 70 is opened to bypass the exhaust gas, as shown by L4.

As described above, according to one or more embodiments of the present disclosure, a concentrated catalyst combustion system including an active concentration rate control means is able to burn VOCs without using auxiliary fuel by concentrating the VOCs to a combustible concentration even when the concentration of the VOCs contained in the exhaust gas varies. Thus, energy is saved, and there is an advantage that the combustion heat of the VOCs may be recovered and recycled for the combustion of VOCs.

The absorption blower fan 10 is arranged at the front end of the VOC concentrator 20 and at the front end of the bypass duct 14 to improve the flow rate regulation effect of the exhaust gas. Since the exhaust gas presses the bypass duct 14 with the pressure from the absorption blower fan 10, the flow rate easily flows into the bypass duct 14. According to the existing prior art document, when an absorption blower fan is arranged at the rear end of a concentrator, if exhaust gas is absorbed, there is a problem that the exhaust gas that needs to flow into a bypass duct arranged at the front end of the concentrator flows into the concentrator side due to the absorption power of the absorption blower fan. Thus, one or more embodiments of the present disclosure may solve such problem.

While preferred embodiments of the present disclosure have been illustrated and described in detail with reference to the accompanying drawings, it will be clear that the present disclosure is not limited to thereto. Numerous modifications, changes, variations, substitutions, and equivalents will be apparent to those skilled in the art, without departing from the spirit and scope of the disclosure, as described in the claims. Thus, it is intended that the specification and examples be considered as exemplary only, with the true scope and spirit of the disclosure being indicated by the appended claims.

### EXPLANATION OF REFERENCE NUMERALS DESIGNATING THE MAJOR

10 . . . ELEMENTS OF THE DRAWINGS
10 . . . ABSORPTION BLOWER FAN
11 . . . INVERTER OF ABSORPTION BLOWER FAN
20 . . . VOC CONCENTRATOR
21 . . . ROTATING MEMBER
212 . . . BELT
213 . . . MOTOR
22 . . . FRONT COVER PART
221 . . . FIRST INLET
222 . . . FIRST OUTLET
23 . . . REAR COVER PART
231 . . . SECOND OUTLET
232 . . . THIRD OUTLET
233 . . . SECOND INLET
26 . . . FIRST PARTITION WALL
25 . . . SECOND PARTITION WALL
24 . . . THIRD PARTITION WALL
27 . . . THROUGH HOLE
R1 . . . FIRST REGION
R2 . . . SECOND REGION
R3 . . . THIRD REGION
30 . . . FLOW RATE REGULATING BLOWER FAN
31 . . . INVERTER OF FLOW RATE REGULATING BLOWER FAN
40 . . . CONCENTRATION MEASURER
50 . . . CATALYST COMBUSTOR
51 . . . COMBUSTION CATALYST
52 . . . PREHEATER
53 . . . WASTE HEAT RECOVERY PART
60 . . . CONTROLLER
61 . . . TEMPERATURE RISE CALCULATOR
70 . . . FIRST BYPASS DAMPER
80 . . . HEAT EXCHANGER
90 . . . ELECTRIC HEATER
100 . . . DILUTED AIR INJECTION DAMPER
110 . . . SECOND BYPASS DAMPER
120 . . . PRETREATMENT FILTER
12 . . . INLET DUCT
13 . . . CONCENTRATED GAS INLET DUCT
14 . . . BYPASS DUCT
15 . . . RETURN DUCT

1. A concentrated catalyst combustion system including an active concentration rate control means, the system comprising:
an absorption blower fan absorbing exhaust gas containing volatile organic compounds (VOCs);
a VOC concentrator into which the exhaust gas passing through the absorption blower fan is introduced, and in which adsorption and desorption of the VOCs are carried out;
a flow rate regulating blower fan absorbing a portion of the exhaust gas flowing into the VOC concentrator in a direction in which the VOCs are desorbed;
a concentration measurer, arranged between the VOC concentrator and the flow rate regulating blower fan, measuring the concentration of the VOCs after desorption;
a catalyst combustor burning concentrated VOCs provided by the flow rate regulating blower fan;
a controller controlling the flow rate regulating blower fan to regulate the flow rate absorbed from the VOC concentrator, to maintain within a certain range the concentration of the VOCs measured by the concentration measurer; and
a first bypass damper, branched from a line connecting the absorption blower fan and the VOC concentrator and connected to a line connecting the VOC concentrator and the concentration measurer, and bypassing the exhaust gas that has passed through the absorption blower fan before the exhaust gas flows into the VOC concentrator.

2. The system of claim 1,
wherein the controller
includes a temperature rise calculator calculating a temperature rise according to the concentration of the VOCs after desorption and
regulates the flow rate absorbed by the flow regulating blower fan, such that the relationship A+B<C is satisfied when the combustion start temperature at which combustion starts in the catalyst combustor is A ° C., the temperature rise calculated by the temperature rise calculator is B ° C., and the heat resistance temperature of the combustion catalyst used in the catalyst combustor is C ° C.

3. The system of claim 1, wherein a heat exchanger and an electric heater are sequentially arranged on a flow path where a portion of the exhaust gas is discharged from the VOC concentrator and flows back into the VOC concentrator, and
a second bypass damper is arranged between the line connecting the VOC concentrator and the heat exchanger and the line connecting the heat exchanger and the electric heater to introduce a portion of the exhaust gas passing through the VOC concentrator to the front end of the electric heater.

4. The system of claim 1, wherein a diluted air injection damper is arranged on the line connecting the VOC concentrator and the concentration measurer to inject diluted air.
